(19) United States
(12) Patent Application Publication
(10) Pub. No.: US 2022/0331950 A1
(43) Pub. Date: Oct. 20, 2022

(54) ROBOT DEVICE AND LIQUID SUPPLY DEVICE

(71) Applicant: AISIN CORPORATION, Kariya, Aichi (JP)

(72) Inventors: Masahiro ASAI, Kariya-shi, Aichi-ken (JP); Tomomi ISHIKAWA, Kariya-shi, Aichi-ken (JP); Tomonari OKAMOTO, Kariya-shi, Aichi-ken (JP); Shinya ICHIKAWA, Kariya-shi, Aichi-ken (JP); Noriomi FUJII, Kariya-shi, Aichi-ken (JP); Ryo TAKADA, Kariya-shi, Aichi-ken (JP); Jin IZAWA, Kariya-shi, Aichi-ken (JP); Hiroki TAKATA, Kariya-shi, Aichi-ken (JP); Hiroshi YAMADA, Kariya-shi, Aichi-ken (JP)

(73) Assignee: AISIN CORPORATION, Kariya, Aichi (JP)

(21) Appl. No.: 17/632,316

(22) PCT Filed: Sep. 14, 2020
(86) PCT No.: PCT/JP2020/034777

§ 371 Date: Feb. 2, 2022

(30) Foreign Application Priority Data
Sep. 30, 2019 (JP) 2019-179916

(51) Int. Cl. B25J 9/14; B25J 9/10; B25J 17/00

(52) U.S. Cl. CPC B25J 9/142; B25J 9/1075; B25J 17/00

(57) ABSTRACT

A robot device of the present disclosure includes at least one artificial muscle that operates by being supplied with liquid; and a liquid supply device that supplies and discharges the liquid to/from the artificial muscle, and the liquid supply device includes a liquid storage part that stores the liquid; a pump that sucks the liquid from the liquid storage part and discharges the liquid; a pressure regulating device that includes a spool and an electromagnetic part that allows the spool to move, and that generates drive pressure for the artificial muscle by regulating source pressure from the pump side, and regulates the source pressure by balancing at least a force given to the spool from the electromagnetic part and a force given to the spool by action of the drive pressure; and a control device that applies a current to the electromagnetic part of the pressure regulating device so that the drive pressure reaches target pressure.

### CROSS REFERENCE TO RELATED APPLICATIONS

This application is a National Stage of International Application No. PCT/JP2020/034777 filed Sep. 14, 2020, which designates the United States, incorporated herein by reference, and which claims the benefit of priority from Japanese Patent Application No. 2019-179916 filed Sep. 30, 2019, the entire contents of which are incorporated herein by reference.

The present disclosure relates to a robot device including at least one artificial muscle that operates by being supplied with liquid, and to a liquid supply device that supplies and discharges liquid to/from the artificial muscle.

### BACKGROUND ART

Conventionally, for a fluid pressure actuator that forms a McKibben artificial muscle, there is known a fluid pressure actuator including: an actuator main body part including a cylindrical tube that expands and contracts by fluid pressure, and a sleeve which is a structure obtained by braiding cords oriented in a predetermined direction and which covers an outer circumferential surface of the tube; and a sealing mechanism that seals an end part of the actuator main body part in an axial direction of the actuator main body part (see, for example, Patent Literature 1). The fluid pressure actuator can obtain a tensile force by supplying fluid into the tube to allow the tube to radially expand and axially contract. For a device that allows such a fluid pressure actuator that forms an artificial muscle to contract, there is generally known a compressed-air supply device that supplies compressed air into a tube (see, for example, Patent Literature 2).

On the other hand, in recent years, there has been proposed driving of a fluid pressure actuator such as that described above by liquid pressure such as oil pressure (see, for example, Non-Patent Literature 1). According to a hydraulic actuator using liquid such as hydraulic oil or water as working fluid, it becomes possible to further increase a force-to-self-weight ratio compared to a motor and a hydraulic cylinder. For a drive device for the hydraulic actuator, a drive device is generally used that regulates pressure of hydraulic oil supplied to a tube by controlling the flow rate of the hydraulic oil supplied into the tube, as with a so-called hydraulic cylinder, etc. For example, Non-Patent Literature 2 describes, as a device that supplies oil into a tube of an artificial muscle, a device including a pump and a high-pressure flow control valve controlled by a flow control valve using particle excitation which serves as a pilot valve. In addition, for a device that supplies oil into a tube of an artificial muscle, there is also known a device that controls the number of revolutions of a pump, i.e., discharge flow rate, so that oil pressure supplied to the tube which is detected by a pressure sensor reaches a required value.

### CITATIONS LIST

### Patent Literature

Patent Literature 1: JP 2018-35930 A

Patent Literature 2: JP 2012-125847 A

### Non-Patent Literature

Non-Patent Literature 1: Fluid Power System, Vol. 50, No. 2, March 2019, pp. 65-68

Non-Patent Literature 2: Evaluation of Flow Control Valve using Particle Excitation for High Pressure Artificial Muscle, No. 19-2 Proceedings of the 2019 JSME Conference on Robotics and Mechatronics, Hiroshima, Japan, Jun. 5-8, 2019

### SUMMARY OF DISCLOSURE

### Technical Problems

However, when, as described above, feedback control is performed on the flow control valve or the pump (the discharge flow rate of the pump) based on liquid pressure supplied to the tube which is detected by the pressure sensor, it takes time for liquid pressure in the tube to reach a required value and it becomes difficult to allow the hydraulic actuator to operate with excellent responsiveness. In addition, when a control gain is increased to improve the responsiveness to changes in liquid pressure, oscillation occurs in liquid pressure supplied to the tube, resulting in overshoot and undershoot. Namely, for a drive device for the hydraulic actuator, there has not been proposed so far any drive device having sufficient practicality, and there is a demand for a drive device that can allow the hydraulic actuator to operate with excellent responsiveness and high accuracy.

Therefore, the present disclosure allows an artificial muscle that operates by being supplied with liquid to operate with excellent responsiveness and high accuracy.

### Solutions to Problems

A robot device of the present disclosure includes: at least one artificial muscle that operates by being supplied with liquid; and a liquid supply device that supplies and discharges the liquid to/from the artificial muscle, and the liquid supply device includes: a liquid storage part that stores the liquid; a pump that sucks the liquid from the liquid storage part and discharges the liquid; a pressure regulating device that includes a spool and an electromagnetic part that allows the spool to move, and that generates drive pressure for the artificial muscle by regulating source pressure from a pump side, and regulates the source pressure by balancing at least a force given to a spool from the electromagnetic part and a force given to the spool by action of the drive pressure; and a control device that applies a current to the electromagnetic part of the pressure regulating device so that the drive pressure reaches target pressure.

The inventors of the present invention have conducted intensive studies to allow an artificial muscle that operates by being supplied with liquid to operate with excellent responsiveness and high accuracy. As a result, the inventors have focused on pressure control that has not been yet applied to liquid-driven artificial muscles. Then, the inventors have confirmed that by regulating pressure of liquid to target pressure required for operation of the artificial muscle and supplying the liquid to the artificial muscle, drive pressure supplied to the artificial muscle can substantially match the target pressure within a short period of time after setting the target pressure. Thus, it becomes possible for the robot device of the present disclosure to allow the artificial muscle that operates by being supplied with liquid to operate with excellent responsiveness and high accuracy.

### BRIEF DESCRIPTION OF DRAWINGS

FIG. 1 is a schematic configuration diagram showing a liquid supply device of the present disclosure.

FIG. 2 is a block diagram showing a control device in the liquid supply device of the present disclosure.

FIG. 3 is a flowchart exemplifying a control routine performed by the control device of FIG. 2.

FIG. 4 is an illustrative diagram exemplifying a required oil pressure setting map.

FIG. 5 is an illustrative diagram exemplifying changes over time of the required oil pressure and actual oil pressure of liquid and the required contraction rate and actual contraction rate of a tube of a hydraulic actuator in the liquid supply device of the present disclosure.

FIG. 6 is an illustrative diagram exemplifying changes over time of the instructed flow rate, actual flow rate, and actual oil pressure of liquid and the required contraction rate and actual contraction rate of a tube of a hydraulic actuator in a first comparative example.

FIG. 7 is an illustrative diagram exemplifying changes over time of the instructed flow rate, actual flow rate, required oil pressure, and actual oil pressure of liquid and the required contraction rate and actual contraction rate of a tube of a hydraulic actuator in a second comparative example.

FIG. 8 is an illustrative diagram exemplifying changes over time of the instructed flow rate, actual flow rate, required oil pressure, and actual oil pressure of liquid and the required contraction rate and actual contraction rate of a tube of a hydraulic actuator in a third comparative example.

FIG. 9 is a schematic configuration diagram showing another liquid supply device of the present disclosure.

FIG. 10 is a plan view showing another actuator unit including a plurality of hydraulic actuators.

FIG. 11 is a side view showing the actuator unit of FIG. 10.

### DESCRIPTION OF EMBODIMENTS

Next, an embodiment for carrying out various aspects of the present disclosure will be described with reference to the drawings.

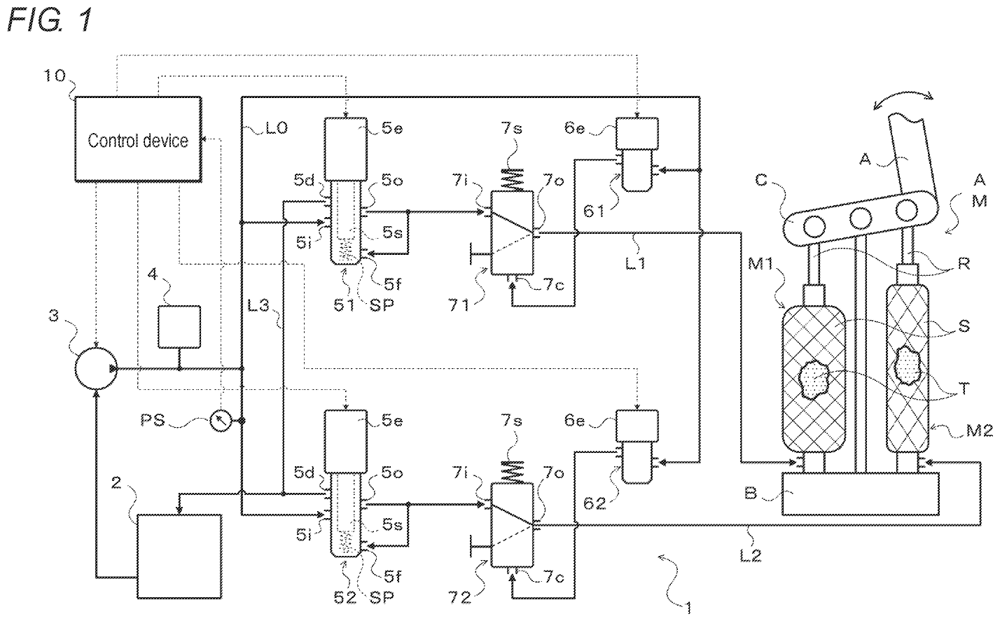

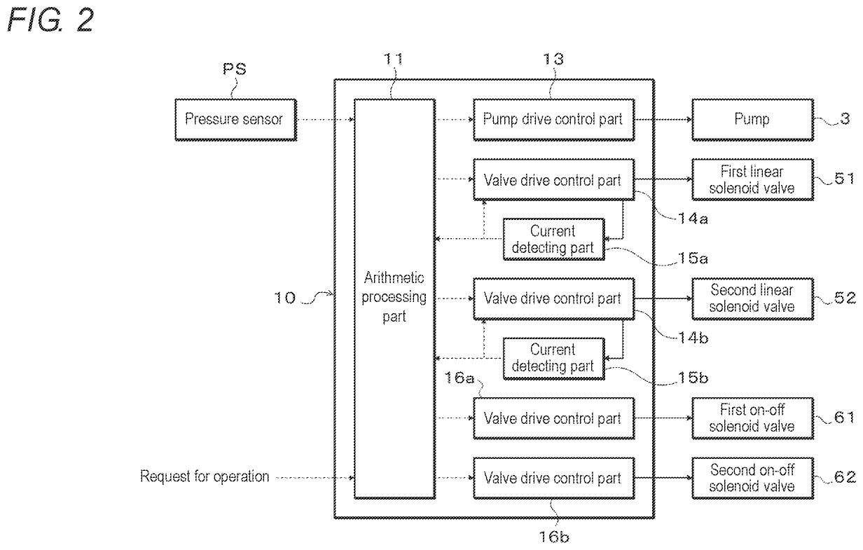

FIG. 1 is a schematic configuration diagram showing a liquid supply device 1 of the present disclosure. The liquid supply device 1 shown in the drawing is a drive device that drives an artificial muscle unit AM using oil pressure by supplying and discharging hydraulic oil (liquid) to/from two hydraulic actuators M1 and M2 included in the artificial muscle unit AM. The artificial muscle unit AM includes, as shown in the drawing, a base member B, a link C supported by the base member B, and a moving arm A fixed to or integrated with the link C, in addition to the two hydraulic actuators M1 and M2. The artificial muscle unit AM forms, together with the liquid supply device 1, a robot device of the present disclosure that includes, for example, a hand part and a robot arm. Note, however, that the artificial muscle unit AM may form a robot device including a robot arm having attached to its end an element other than the hand part, such as a tool, e.g., a drill bit, or a pressing member that presses, for example, a switch, a walking robot, a wearable robot, etc. The hydraulic actuators M1 and M2 of the artificial muscle unit AM both form McKibben artificial muscles, and in the present embodiment, the hydraulic actuators M1 and M2 have the same specifications. Each of the hydraulic actuators M1 and M2 includes a tube T that expands and contracts by pressure of hydraulic oil; and a braided sleeve S that covers the tube T.

The tube T of each of the hydraulic actuators M1 and M2 is formed in cylindrical shape and made of, for example, an elastic material having high oil resistance such as a rubber material, and both end parts of the tube T are sealed by sealing members. An inlet and an outlet for hydraulic oil are formed in the sealing member on one end side (lower end side in the drawing) of the tube T, and a connecting rod R is fixed to the sealing member on the other end side (upper end side in the drawing) of the tube T. The braided sleeve S is formed in cylindrical shape by braiding a plurality of cords oriented in a predetermined direction such that the cords cross each other, and can contract axially and radially. For the cords that form the braided sleeve S, fiber cords, high-strength fibers, metal cords made of fine filaments, etc., can be adopted. By supplying hydraulic oil into the tube T of each of the hydraulic actuators M1 and M2 through the inlet and outlet to increase pressure of hydraulic oil in the tube T, the tube T radially expands and axially contracts by action of the braided sleeve S.

In the artificial muscle unit AM, the sealing member on the one end side (hydraulic oil inlet and outlet side) of each of the hydraulic actuators M1 and M2 is connected to the base member B via, for example, a joint such as a universal joint, or is fixed to the base member B. In addition, an end part of the connecting rod R of each of the hydraulic actuators M1 and M2 is pivotably connected to a corresponding end part of the link C. Furthermore, a central part in a longitudinal direction of the link C is pivotably supported by the base member B. By this, oil pressure in the tube T of the hydraulic actuator M1 differs from oil pressure in the tube T of the hydraulic actuator M2, by which the link C and the moving arm A which are drive targets pivot (move) with respect to the base member B to change the pivot angles of the link C and the moving arm A with respect to the base member B, and forces can be transmitted to the moving arm A from the hydraulic actuators M1 and M2. In the present embodiment, a pair of the hydraulic actuators M1 and M2 is antagonistically driven by oil pressure from the liquid supply device 1, with a state of the tubes T axially contracting by a predetermined amount (e.g., on the order of 10% of equilibrium length) being an initial state.

As shown in FIG. 1, the liquid supply device 1 includes a tank 2 serving as a liquid storage part that stores hydraulic oil; a pump 3; an accumulator 4 that accumulates oil pressure generated by the pump 3; first and second linear solenoid valves 51 and 52 serving as pressure regulating devices that generate drive pressure for their corresponding hydraulic actuators M1 and M2 by regulating source pressure from a pump 3 side; first and second on-off solenoid valves 61 and 62; first and second on-off valves 71 and 72; and a control device 10 that controls the pump 3, the first and second linear solenoid valves 51 and 52, and the first and second on-off solenoid valves 61 and 62. The pump 3 is, for example, a motor-driven pump, and sucks hydraulic oil from the tank 2 and discharges the hydraulic oil to an oil passage (liquid passage) L0 formed in a valve body which is not shown. In addition, the accumulator 4 is connected to the oil passage (liquid passage) L0 near a discharge port of the pump 3.

The first and second linear solenoid valves 51 and 52 each include an electromagnetic part 5e whose current passage is controlled by the control device 10, a spool 5s, a spring SP that biases the spool 5s toward an electromagnetic part 5e side (from an output port 5o side to an input port 5i side, an upper side of FIG. 1), etc., and are disposed in the valve body. In addition, the first and second linear solenoid valves 51 and 52 each include the input port 5i that communicates with the oil passage L0 of the valve body; the output port 5o that can communicate with the input port 5i; a feedback port 5f that communicates with the output port 5o; and a drain port 5d that can communicate with the input port 5i and the output port 5o. In the present embodiment, the first and second linear solenoid valves 51 and 52 each are a normally closed valve that opens when a current is supplied to the electromagnetic part 5e, and each electromagnetic part 5e allows a corresponding spool 5s to axially move according to a current applied thereto. By this, thrust given to the spool 5s from the electromagnetic part 5e (coil) by feeding the electromagnetic part 5e, a biasing force of the spring SP, and thrust toward the electromagnetic part 5e side that is given to the spool 5s by action of oil pressure (drive pressure) supplied to the feedback port 5f from the output port 5o are balanced, by which hydraulic oil from the pump 3 side supplied to the input port 5i can flow out from the output port 5o such that the hydraulic oil flowing out from the output port 5o has desired pressure. In addition, as shown in FIG. 1, the drain ports 5d of the first and second linear solenoid valves 51 and 52 each communicate with the inside of the tank 2 (liquid storage part) through an oil passage L3 formed in the valve body.

The first and second on-off solenoid valves 61 and 62 each include an electromagnetic part 6e whose current passage is controlled by the control device 10; an input port that communicates with the oil passage L0; and an output port. The first and second on-off solenoid valves 61 and 62 each output signal pressure by allowing hydraulic oil from the pump 3 side supplied to the input port to flow out from the output port according to passage of a current to the electromagnetic part 6e.

The first and second on-off valves 71 and 72 each are a normally closed spool valve including a spool which is not shown and a spring 7s, and are disposed in the valve body. The first on-off valve 71 includes an input port 7i that communicates with the output port 5o of the first linear solenoid valve 51 through an oil passage formed in the valve body; an output port 7o that communicates with the inlet and outlet for hydraulic oil of the hydraulic actuator M1 (tube T) through an oil passage L1 formed in the valve body; and a signal pressure input port 7c that communicates with the output port of the first on-off solenoid valve 61 through an oil passage formed in the valve body. In addition, the second on-off valve 72 includes an input port 7i that communicates with the output port 5o of the second linear solenoid valve 52 through an oil passage formed in the valve body; an output port 7o that communicates with the inlet and outlet for hydraulic oil of the hydraulic actuator M2 (tube T) through an oil passage L2 formed in the valve body; and a signal pressure input port 7c that communicates with the output port of the second on-off solenoid valve 62 through an oil passage formed in the valve body.

When signal pressure is not supplied to the signal pressure input port 7c from the first or second on-off solenoid valve 61 or 62, the spool of a corresponding one of the first and second on-off valves 71 and 72 shuts down communication between the input port 7i and the output port 7o by a biasing force of the spring 7s, and closes the output port 7o, i.e., the oil passage L1 or L2 (see a dashed line in the drawing). In addition, when signal pressure is supplied to the signal pressure input port 7c from the first or second on-off solenoid valve 61 or 62 according to passage of a current to the electromagnetic part 6e, the spool of a corresponding one of the first and second on-off valves 71 and 72 allows the input port 7i and the output port 7o to communicate with each other against a biasing force of the spring 7s (see a solid line in the drawing).

The control device 10 in the liquid supply device 1 includes a microcomputer including a CPU, a ROM, a RAM, an input-output interface, etc., various types of logic ICs, etc. (none of them are shown). The control device 10 accepts, as input, detection values of a pressure sensor PS that detects pressure of hydraulic oil in the oil passage L0 on a downstream side of the accumulator 4, voltage sensors (not shown) that detect voltages at power supplies for the first and second linear solenoid valves 51 and 52 and the first and second on-off solenoid valves 61 and 62, various types of sensors provided in the artificial muscle unit AM, etc.

In addition, in the control device 10, by at least either one of hardware such as the CPU, the ROM, the RAM, and the logic ICs and software such as various types of programs installed in the ROM, there are constructed, as functional blocks (modules), an arithmetic processing part 11, a pump drive control part 13 connected to the pump 3, a valve drive control part 14a connected to the first linear solenoid valve 51, a valve drive control part 14b connected to the second linear solenoid valve 52, a current detecting part 15a that detects a current flowing through the electromagnetic part 5e of the first linear solenoid valve 51, a current detecting part 15b that detects a current flowing through the electromagnetic part 5e of the second linear solenoid valve 52, a valve drive control part 16a connected to the first on-off solenoid valve 61, and a valve drive control part 16b connected to the second on-off solenoid valve 62.

When oil pressure in the oil passage L0 detected by the pressure sensor PS is less than or equal to a predetermined pump drive threshold value, the arithmetic processing part 11 in the control device 10 transmits a pump drive instruction to the pump drive control part 13 until the oil pressure in the oil passage L0 reaches a predetermined pump stop threshold value. In addition, the arithmetic processing part 11 sets required oil pressure (target pressure) Preq1 that is required for operation of the hydraulic actuator M1 and required oil pressure (target pressure) Preq2 that is required for operation of the hydraulic actuator M2. Furthermore, the arithmetic processing part 11 calculates a target current value Itag1 which is a target value of a current supplied to the electromagnetic part 5e of the first linear solenoid valve 51 and which corresponds to the required oil pressure Preq1, and a target current value Itag2 which is a target value of a current supplied to the electromagnetic part 5e of the second linear solenoid valve 52 and which corresponds to the required oil pressure Preq2.

In addition, the arithmetic processing part 11 transmits an on instruction for opening the first and second on-off valves 71 and 72 to the valve drive control parts 16a and 16b while the artificial muscle unit AM operates. Furthermore, the arithmetic processing part 11 monitors currents detected by the current detecting parts 15a and 15b, and for example, when a value obtained by subtracting a current detected by the current detecting part 15a and/or 15b from a target current value is greater than or equal to a predetermined threshold value, the arithmetic processing part 11 considers that an abnormality has occurred in supply of hydraulic oil from at least either one of the first and second linear solenoid valves 51 and 52 to a corresponding one of the hydraulic actuators M1 and M2, and thus transmits an off instruction for closing a corresponding one of the first and second on-off valves 71 and 72 to a corresponding one of the valve drive control parts 16a and 16b.

The pump drive control part 13 in the control device 10 controls (duty control) the pump 3 to suck hydraulic oil from the tank 2 and discharge the hydraulic oil, while receiving a pump drive instruction from the arithmetic processing part 11. Namely, the pump 3 is intermittently driven so that oil pressure in the oil passage L0 detected by the pressure sensor PS is maintained at predetermined target pressure, and while the pump 3 is stopped, hydraulic oil accumulated in the accumulator 4 flows into the oil passage L0, by which oil pressure (source pressure) in the oil passage L0 is maintained at the target pressure. By this, it becomes possible to reduce power consumption of the pump 3.

The valve drive control parts 14a and 14b in the control device 10 each include a target voltage setting part, a PWM signal generating part, and a solenoid drive circuit. The target voltage setting part in the valve drive control part 14a calculates a target voltage Vtag1 which is a target value of a voltage applied to the electromagnetic part 5e of the first linear solenoid valve 51. In addition, the target voltage setting part in the valve drive control part 14b sets a target voltage Vtag2 which is a target value of a voltage applied to the electromagnetic part 5e of the second linear solenoid valve 52. More specifically, each target voltage setting part calculates, as a feedforward voltage, the product of a target current value Itag1 or Itag2 and a resistance value (estimated value) of the electromagnetic part 5e which is calculated from a value of a target voltage Vtag1 or Vtag2 obtained last time and the target current value Itag1 or Itag2 taking into account the temperature of hydraulic oil. In addition, each target voltage setting part calculates a feedback voltage by PI control or PID control based on a difference between the target current value Itag1 or Itag2 and a current detected by the current detecting part 15a or 15b. Then, each target voltage setting part outputs a target voltage Vtag1 or Vtag2 obtained by combining together the feedforward voltage and the feedback voltage. Note, however, that the target voltage setting parts may set target voltages only by feedforward control.

The PWM signal generating parts in the valve drive control parts 14a and 14b each convert a corresponding one of the target voltages Vtag1 and Vtag2 into a PWM signal. The solenoid drive circuits in the valve drive control parts 14a and 14b each include, for example, two switching elements (transistors) and apply a current to the electromagnetic part 5e of a corresponding one of the first and second linear solenoid valves 51 and 52 according to the PWM signal from a corresponding PWM signal generating part. By this, the first and second linear solenoid valves 51 and 52 are controlled to generate oil pressure determined based on required oil pressure (target currents).

The valve drive control parts 16a and 16b in the control device 10 each supply a current to the electromagnetic part 6e of a corresponding one of the first and second on-off solenoid valves 61 and 62 so as to output signal pressure to a corresponding one of the first and second on-off valves 71 and 72, while receiving an on instruction from the arithmetic processing part 11. In addition, when the valve drive control part 16a or 16b receives an off instruction from the arithmetic processing part 11, the valve drive control part 16a or 16b stops the supply of a current to the electromagnetic part 6e of a corresponding one of the first and second on-off solenoid valves 61 and 62 so as to stop the output of signal pressure to a corresponding one of the first and second on-off valves 71 and 72.

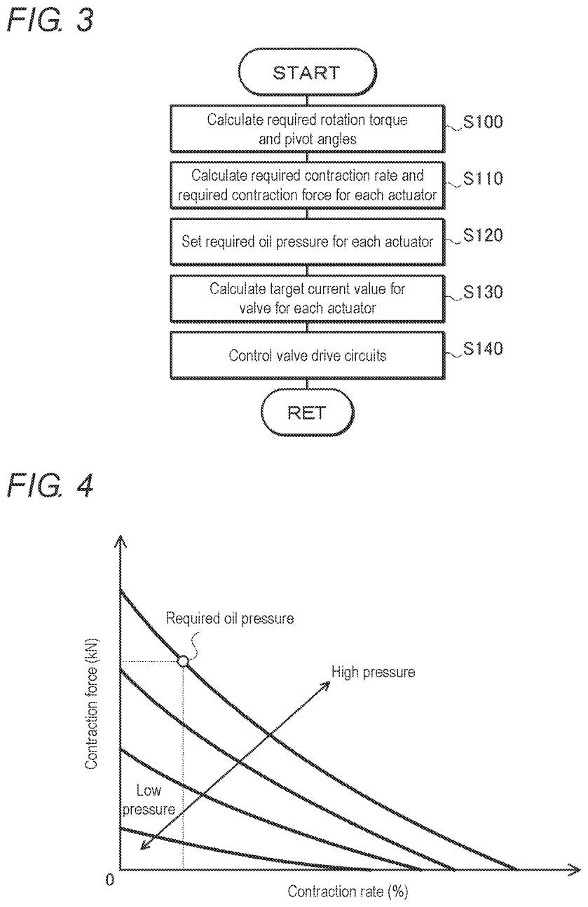

Next, with reference to FIGS. 3 to 5, etc., a procedure for allowing the artificial muscle unit AM to operate by supplying hydraulic oil to each of the hydraulic actuators M1 and M2 from the liquid supply device 1 will be described.

FIG. 3 is a flowchart exemplifying a control routine performed by the control device 10 in response to a request for operation of the artificial muscle unit AM. Note that when the artificial muscle unit AM operates by supplying hydraulic oil to each of the hydraulic actuators M1 and M2 from the liquid supply device 1, the first and second on-off valves 71 and 72 are allowed to open by the control device 10. Then, the arithmetic processing part 11 in the control device 10 starts the control routine of FIG. 3 when receiving a request for operation of the moving arm A of the artificial muscle unit AM from a control device (not shown) for the artificial muscle unit AM.

Upon start of the routine of FIG. 3, the arithmetic processing part 11 in the control device 10 calculates rotation torque and a pivot angle that are required for operation of the hydraulic actuator M1 and rotation torque and a pivot angle that are required for operation of the hydraulic actuator M2 (step S100). Furthermore, the arithmetic processing part 11 derives a required contraction rate and a required contraction force for the hydraulic actuator M1 and a required contraction force and a required contraction rate for the hydraulic actuator M2 from the rotation torque and pivot angles calculated at step S100 (step S110). The contraction rates each represent a ratio of the axial length of the contracted tube T to the equilibrium axial length of a corresponding one of the hydraulic actuators M1 and M2, and the contraction forces each represent a force generated by contraction of the tube T.

Then, the arithmetic processing part 11 sets required oil pressure (target pressure) Preq1 required for operation of the hydraulic actuator M1 and required oil pressure (target pressure) Preq2 required for operation of the hydraulic actuator M2, based on the required contraction forces and required contraction rates calculated at step S110 (step S120). At step S120, the arithmetic processing part 11 derives pressure corresponding to the required contraction force and required contraction rate of the hydraulic actuator M1 calculated at step S110 from a required oil pressure setting map exemplified in FIG. 4, and sets the pressure as required oil pressure Preq1. In addition, the arithmetic processing part 11 derives pressure corresponding to the required contraction force and required contraction rate of the hydraulic actuator M2 calculated at step S110 from the required oil pressure setting map, and sets the pressure as required oil pressure Preq2. The required oil pressure setting map of FIG. 4 shows static characteristics of the hydraulic actuators M1 and M2 serving as artificial muscles, and is created in advance by performing experiments and analysis so as to define a relationship between the contraction rate of the tube T and contraction force generated by the tube T, for each oil pressure supplied to the hydraulic actuators M1 and M2.

After setting the required oil pressure Preq1 and required oil pressure Preq2 for the first and second hydraulic actuators M1 and M2 at step S120, the arithmetic processing part 11 calculates a target current value Itag1 corresponding to the required oil pressure Preq1 and a target current value Itag2 corresponding to the required oil pressure Preq2 (step S130). Then, the arithmetic processing part 11 provides the target current value Itag1 to the valve drive control part 14a and provides the target current value Itag2 to the valve drive control part 14b (step S140), and temporarily ends the routine of FIG. 3.

By this, a current based on the target current value Itag1 is applied to the electromagnetic part 5e of the first linear solenoid valve 51 by the valve drive control part 14a, by which the first linear solenoid valve 51 is controlled to generate oil pressure, i.e., drive pressure, determined based on the required oil pressure Preq1. In addition, a current based on the target current value Itag2 is applied to the electromagnetic part 5e of the second linear solenoid valve 52 by the valve drive control part 14b, by which the second linear solenoid valve 52 is controlled to generate oil pressure, i.e., drive pressure, determined based on the required oil pressure Preq2. Hydraulic oil regulated by the first linear solenoid valve 51 is supplied to the tube T of the hydraulic actuator M1 through the first on-off valve 71 and the oil passage L1, and hydraulic oil regulated by the second linear solenoid valve 52 is supplied to the tube T of the hydraulic actuator M2 through the second on-off valve 72 and the oil passage L2.

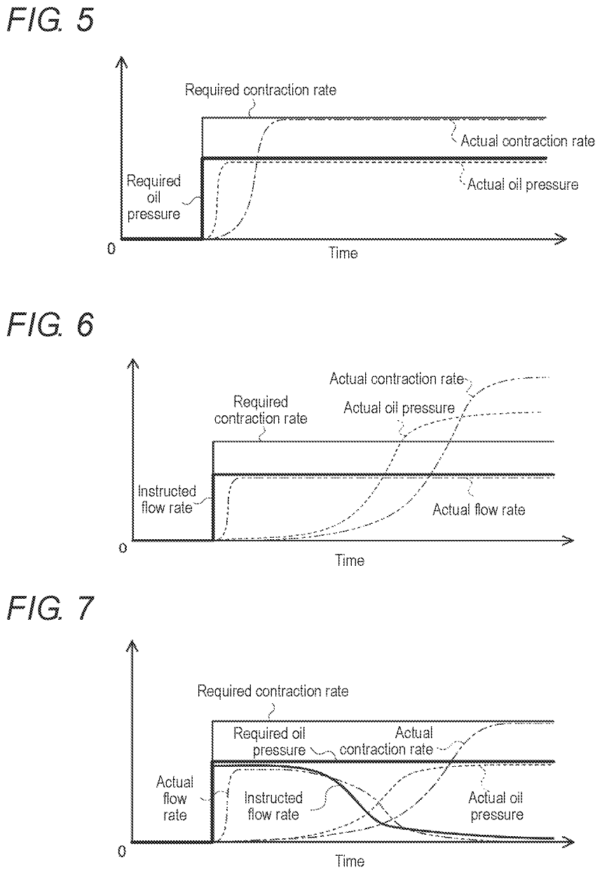

As described above, the liquid supply device 1 regulates pressure of hydraulic oil to required oil pressure (target pressure) Preq1 and Preq2 that are required for operation of each of the hydraulic actuators M1 and M2, and supplies the hydraulic oil into the tube T of each of the hydraulic actuators M1 and M2. Namely, the inventors of the present disclosure have conducted intensive studies to allow a hydraulic actuator serving as an artificial muscle to operate with excellent responsiveness and high accuracy, and as a result, the inventors have focused on pressure control that has not been yet applied to liquid-driven artificial muscles. Then, the inventors have confirmed that by regulating pressure of hydraulic oil to required oil pressure (target pressure) and supplying the hydraulic oil into a tube, as shown in FIG. 5, actual oil pressure of the hydraulic oil supplied to the tube substantially matches the required oil pressure within a short period of time after setting the required oil pressure, and an actual contraction rate of the tube substantially matches a required contraction rate, promptly following the actual oil pressure.

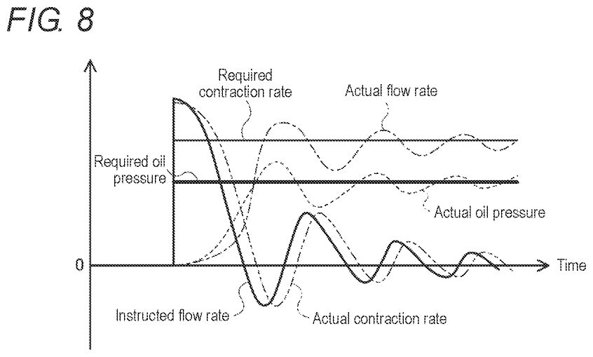

Here, when the flow rate of hydraulic oil is regulated by a flow control valve and the hydraulic oil is supplied into a tube, as shown in FIG. 6, although the flow rate (actual flow rate) of liquid flowing out from the flow control valve promptly and substantially matches an instructed flow rate, actual oil pressure of the hydraulic oil supplied to the tube changes as indicated by a dashed line in the drawing, and an actual contraction rate of the tube deviates from a required contraction rate. In addition, for example, even if actual oil pressure of hydraulic oil supplied to the tube is detected by a pressure sensor and the flow control valve is feedback-controlled so that the actual oil pressure matches required oil pressure, as shown in FIG. 7, it takes time for the actual oil pressure of the hydraulic oil supplied to the tube to reach the required oil pressure, and it further takes time for an actual contraction rate of the tube to substantially match a required contraction rate. In addition, when a control gain is increased to improve responsiveness to changes in oil pressure and contraction rate, as shown in FIG. 8, oscillation occurs in oil pressure supplied to the tube and the contraction rate of the tube, resulting in overshoot and undershoot.

Thus, it is to be understood from FIGS. 5 to 8 that by regulating pressure of hydraulic oil to required oil pressure (target pressure) Preq1 and Preq2 that are required for operation of the hydraulic actuators M1 and M2 and supplying the hydraulic oil into the tubes T, the hydraulic actuators M1 and M2 can operate with excellent responsiveness and high accuracy. Namely, according to the liquid supply device 1, it becomes possible to allow the tubes T of the hydraulic actuators M1 and M2 to axially contract with excellent responsiveness and high accuracy according to requirements, and accurately adjust the pivot angle of the moving arm A and forces transmitted to the moving arm A from the hydraulic actuators M1 and M2.

In addition, the first and second linear solenoid valves 51 and 52 of the liquid supply device 10 each regulate source pressure from the pump 3 side by balancing thrust given to the spool 5s from the electromagnetic part 5e, a biasing force of the spring SP, and thrust given to the spool 5s by action of oil pressure (drive pressure) supplied to the feedback port 5f from the output port 5o. By thus feeding back drive pressure which is oil pressure supplied to the hydraulic actuators M1 and M2 to the first and second linear solenoid valves 51 and 52, when an external force from a source other than the hydraulic actuators M1 and M2 serving as artificial muscles is applied to the link C or the moving arm A driven by the hydraulic actuators M1 and M2, fluctuations in oil pressure based on changes in the volumes of the tubes T of the hydraulic actuators M1 and M2 caused by the external force can be smoothed out. In addition, after the external force is removed, it becomes possible to promptly supply drive pressure determined based on required oil pressure (target pressure) Preq1 and Preq2 to the hydraulic actuators M1 and M2.

Furthermore, the artificial muscle unit AM that forms the robot device of the present disclosure includes the hydraulic actuators M1 and M2 which are a pair of artificial muscles that is antagonistically driven to allow the link C and the moving arm A which are drive targets to pivot (move) with respect to the base member B. In addition, the first and second linear solenoid valves 51 and 52 are provided as pressure regulating devices for a pair of the hydraulic actuators M1 and M2, respectively. Furthermore, the control device 10 controls, for each of the first and second linear solenoid valves 51 and 52, a current applied to the electromagnetic part 5e. By this, it becomes possible to further improve controllability of each of the hydraulic actuators M1 and M2 serving as artificial muscles.

In addition, the control device 10 in the liquid supply device 1 derives required contraction forces and required contraction rates for the tubes T determined based on requirements for the hydraulic actuators M1 and M2, and sets oil pressure corresponding to the required contraction forces and required contraction rates as required oil pressure (target pressure) Preq1 and Preq2 (step S110 and S120 of FIG. 3). By this, it becomes possible to accurately set the required oil pressure Preq1 and Preq2 according to requirements for the hydraulic actuators M1 and M2.

Furthermore, the liquid supply device 1 includes a single pump 3 that sucks hydraulic oil from the tank 2 that stores the hydraulic oil and discharges the hydraulic oil; and the first and second linear solenoid valves 51 and 52 each regulating pressure of hydraulic oil from the pump 3 side and supplying the hydraulic oil into the tube T of a corresponding one of the hydraulic actuators M1 and M2.

By this, it becomes possible to accurately regulate pressure of hydraulic oil (drive pressure) supplied to the tubes T of the hydraulic actuators M1 and M2 to required oil pressure (target pressure) Preq1 and Preq2, and significantly reduce the cost and size of the liquid supply device 1 that supplies hydraulic oil to the plurality of hydraulic actuators M1 and M2, compared to, for example, a liquid supply device including a pump for each hydraulic actuator.

In addition, the control device 10 in the liquid supply device 1 applies, by PWM control, currents generated based on required oil pressure (target pressure) Preq1 and Preq2 to the electromagnetic parts 5e of the first and second linear solenoid valves 51 and 52. By this, it becomes possible to more accurately regulate pressure of hydraulic oil supplied to the tubes T of the hydraulic actuators M1 and M2 to required oil pressure Preq1 and Preq2.

Furthermore, when the control device 10 detects an abnormality in passage of a current in at least either one of the electromagnetic parts 5e of the first and second linear solenoid valves 51 and 52, the control device 10 transmits the above-described off instruction to the valve drive control part 16a and/or 16b so as to stop output of signal pressure from the first and/or second on-off solenoid valves 61 and 62.

By this, at least either one of the first and second on-off valves 71 and 72 is closed according to the stop of output of signal pressure from the first and/or second on-off solenoid valves 61 and 62, by which flow-out of hydraulic oil from a corresponding tube T is restricted. Thus, even if an abnormality occurs in supply of hydraulic oil from at least either one of the first and second linear solenoid valves 51 and 52 to a corresponding tube T, a sudden change in the state of the tube T is inhibited, by which occurrence of unintended operation of the moving arm A which is driven by the hydraulic actuators M1 and M2 can be excellently suppressed. As a result, according to the liquid supply device 1, it becomes possible to allow the hydraulic actuators M1 and M2, i.e., the artificial muscle unit AM, to operate properly and safely.

In addition, in the liquid supply device 1, as shown in FIG. 1, the first on-off valve 71 is disposed between the output port 5o of the first linear solenoid valve 51 and the tube T of the hydraulic actuator M1, and the second on-off valve 72 is disposed between the output port 5o of the second linear solenoid valve 52 and the tube T of the hydraulic actuator M2. By this, when an abnormality occurs in supply of hydraulic oil from at least either one of the first and second linear solenoid valves 51 and 52 to a corresponding tube T, it becomes possible to suppress flow-out of liquid from the tube T extremely excellently.

Furthermore, in the liquid supply device 1, the first and second linear solenoid valves 51 and 52 are normally closed valves that open when currents are supplied to the electromagnetic parts 5e, and the first and second on-off valves 71 and 72 are normally closed valves that open when currents are supplied to the electromagnetic parts 6e of the first and second on-off solenoid valves 61 and 62. By this, when supply of hydraulic oil from the first and second linear solenoid valves 51 and 52 to the tubes T of the hydraulic actuators M1 and M2 is shut off due to power supply failure, the first and second on-off valves 71 and 72 are promptly closed, enabling restrictions on flow-out of hydraulic oil from each tube T.

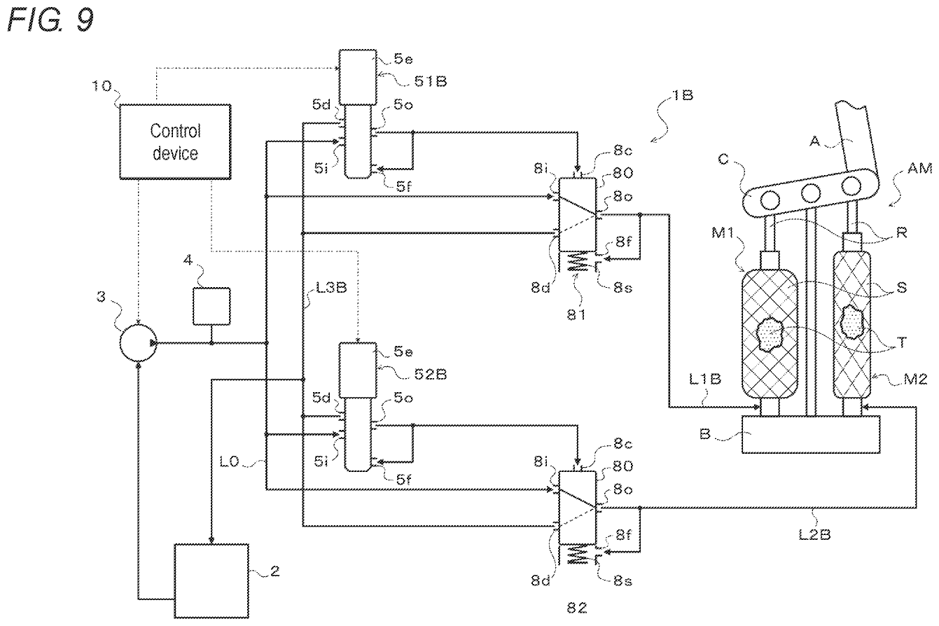

FIG. 9 is a schematic configuration diagram showing another liquid supply device 1B of the present disclosure. Note that of the components of the liquid supply device 1B, the same components as those of the above-described liquid supply device 1 are given the same reference signs and an overlapping description thereof is omitted.

The liquid supply device 1B shown in FIG. 9 includes, as pressure regulating devices for the hydraulic actuator M1, a first linear solenoid valve 51B of a normally closed type that outputs signal pressure generated based on a current supplied to an electromagnetic part 5e, and a first control valve 81 that regulates pressure of hydraulic oil (source pressure) from the pump 3 side, according to the signal pressure from the first linear solenoid valve 51B, and includes, as pressure regulating devices for the hydraulic actuator M2, a second linear solenoid valve 52B of a normally closed type that outputs signal pressure generated based on a current supplied to an electromagnetic part 5e, and a second control valve 82 that regulates pressure of hydraulic oil (source pressure) from the pump 3 side, according to the signal pressure from the second linear solenoid valve 52B. The first and second control valves 81 and 82 are normally closed spool valves each including a spool 80 and a spring 8s, and are disposed in the valve body.

The first control valve 81 includes an input port 8i that communicates with an oil passage L0 formed in the valve body; an output port 8o that communicates with the inlet and outlet for hydraulic oil of the hydraulic actuator M1 (tube T) through an oil passage L1B formed in the valve body; a feedback port 8f that communicates with the output port 8o; a signal pressure input port 8c that communicates with an output port 5o of the first linear solenoid valve 51B through an oil passage formed in the valve body; and a drain port 8d that communicates with the inside of the tank 2 through an oil passage L3B formed in the valve body. In addition, the second control valve 82 includes an input port 8i that communicates with the oil passage L0 formed in the valve body; an output port 8o that communicates with the inlet and outlet for hydraulic oil of the hydraulic actuator M2 (tube T) through an oil passage L2B formed in the valve body; a feedback port 8f that communicates with the output port 8o; a signal pressure input port 8c that communicates with an output port 5o of the second linear solenoid valve 52B through an oil passage formed in the valve body; and a drain port 8d that communicates with the inside of the tank 2 through the oil passage L3B formed in the valve body.

The first and second control valves 81 and 82 each allow the spool 80 to axially move against a biasing force of the spring 8s by signal pressure from a corresponding one of the first and second linear solenoid valves 51B and 52B which is generated based on a current applied to the electromagnetic part 5e. By this, thrust given to the spool 80 by action of the signal pressure, the biasing force of the spring 8s, and thrust acting on the spool 8s by oil pressure (drive pressure) supplied to the feedback port 8f from the output port 8o are balanced, by which a part of hydraulic oil from the pump 3 side supplied to the input port 8i can flow out from the output port 8o such that the hydraulic oil flowing out from the output port 8o has desired pressure.

Note that in the above-described liquid supply device 1, the first on-off solenoid valve 61 and the first on-off valve 71 may be replaced by a two-way solenoid valve including a disc that opens and closes by an electromagnetic part, and the second on-off solenoid valve 62 and the second on-off valve 72 may be replaced by a two-way solenoid valve including a disc that opens and closes by an electromagnetic part. In addition, the above-described liquid supply devices 1 and 1B may include a regulator valve (pressure regulating valve) that regulates pressure of hydraulic oil from the pump 3 according to signal pressure from a signal pressure output valve, and supplies the hydraulic oil to the oil passage L0.

In addition, the liquid supply devices 1 and 1B may supply liquid other than hydraulic oil, such as water, to the hydraulic actuators M1 and M2, and may be configured to supply and discharge liquid to/from a single or three or more hydraulic actuators. Furthermore, the first and second linear solenoid valves 51 and 52 each may be replaced by a flow control valve that is controlled such that liquid pressure (oil pressure) supplied to a corresponding one of the hydraulic actuators M1 and M2 reaches target pressure. In addition, at least either one of the first and second linear solenoid valves 51 and 52 may be a normally open valve. In this case, the normally open valve may balance thrust from an electromagnetic part and thrust generated by liquid pressure supplied to a feedback port such that the thrust acts in the same direction as the thrust from the electromagnetic part, with a biasing force of a spring. At least either one of the first and second linear solenoid valves 51 and 52 may be configured such that the first or second linear solenoid valve 51 or 52 does not have a dedicated feedback port, and output pressure acts as feedback pressure on a spool inside a sleeve that holds the spool (see, for example, JP 2020-41687 A).

Furthermore, in the above-described embodiment, although the hydraulic actuators M1 and M2 serving as artificial muscles are McKibben artificial muscles each including: a tube T into which hydraulic oil is supplied and which axially contracts while radially expanding in accordance with an increase in oil pressure inside the tube T; and a braided sleeve S that covers the tube T, the configuration of the hydraulic actuators M1 and M2 in the artificial muscle unit AM is not limited thereto. Namely, the hydraulic actuators M each may be any hydraulic actuator as long as the hydraulic actuator includes a tube that axially contracts while radially expanding upon supply of liquid to the hydraulic actuator, and may be, for example, an axially fiber-reinforced hydraulic actuator including an inner tubular member formed of an elastic body; an outer tubular member formed of an elastic body and coaxially disposed on an outer side of the inner tubular member; and a fiber layer disposed between the inner tubular member and the outer tubular member (see, for example, JP 2011-137516 A).

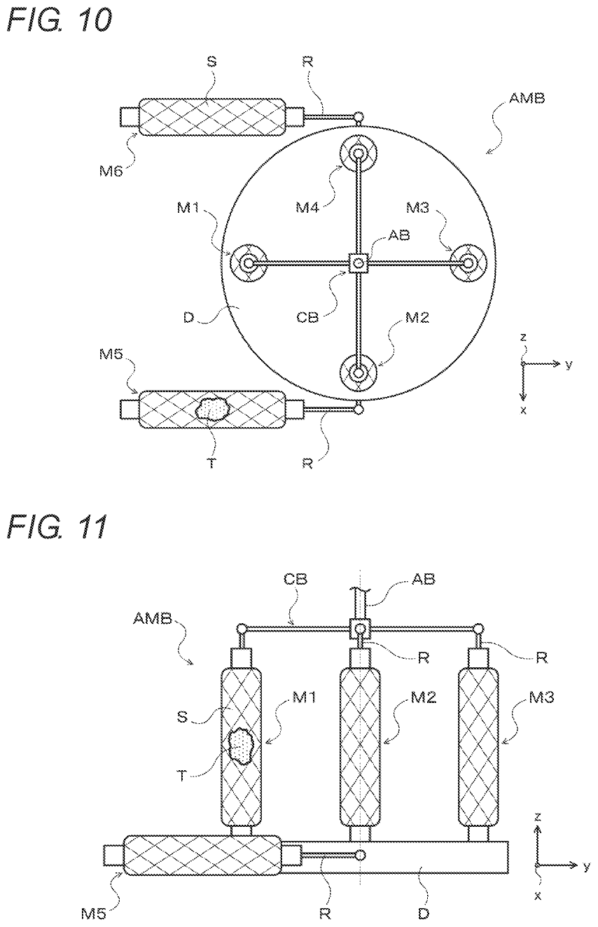

In addition, the liquid supply devices 1 and 1B may be configured to supply liquid to an artificial muscle unit AMB including three or more hydraulic actuators as exemplified in FIGS. 10 and 11. The artificial muscle unit AMB shown in FIGS. 10 and 11 includes six hydraulic actuators M1, M2, M3, M4, M5, and M6; an arm AB; a link CB; and a disc-like rotating member D that is rotatably supported by a base member which is not shown. As shown in the drawings, the hydraulic actuators M1, M2, M3, and M4 are arranged at 90° intervals on the circumference of a circle with the axis of rotation of the rotating member D (see a dashed-dotted line of FIG. 11) being at the center.

In addition, a sealing member on an opposite side to a connecting rod R of each of the hydraulic actuators M1, M2, M3, and M4 is fixed to the rotating member D. Furthermore, ends of the connecting rods R of the hydraulic actuators M1, M2, M3, and M4 each are connected to the link CB via a universal joint. The hydraulic actuators M5 and M6 are fixed to the base member so as to be parallel to each other and orthogonal to the hydraulic actuators M1, M2, M3, and M4. In addition, ends of connecting rods R of the hydraulic actuators M5 and M6 each are connected to the rotating member D via a universal joint. Furthermore, the link CB has the arm AB fixed thereto such that the arm MB, for example, extends coaxially with a central axis of the link CB.

In the artificial muscle unit AMB, by allowing the hydraulic actuators M1, M2, M3, M4, M5, and M6 to selectively contract, the arm AB can pivot around an x-axis and a y-axis of FIGS. 10 and 11 and rotate around a z-axis. Namely, by using actuators M5 and M6, for example, a three-degree-of-freedom articulated mechanism, etc., can be formed. By providing six linear solenoid valves (and six control valves) in the above-described liquid supply devices 1 and 1B, the liquid supply devices 1 and 1B can allow tubes T of the hydraulic actuators M1 to M6 to axially contract with excellent responsiveness and high accuracy according to requirements, and can accurately adjust the position of the arm AB and forces transmitted to the arm AB from the hydraulic actuators M1 to M6.

### [FIG. 3]

### S140 Control Valve Drive Control Part

As described above, the robot device of the present disclosure is a robot device (AM, AMB) including at least one artificial muscle (M1, M2, M1-M6) that operates by being supplied with liquid; and a liquid supply device (1, 1B) that supplies and discharges the liquid to/from the artificial muscle (M1, M2, M1-M6), and the liquid supply device (1, 1B) includes a liquid storage part (2) that stores the liquid; a pump (3) that sucks the liquid from the liquid storage part (2) and discharges the liquid; a pressure regulating device (51, 52, 51B, 52B, 81, 82) that includes a spool (5s, 80) and an electromagnetic part (5e) that allows the spool (5s, 80) to move, and that generates drive pressure for the artificial muscle (M1, M2, M1-M6) by regulating source pressure from a pump (3) side, and regulates the source pressure by balancing at least a force given to a spool (5s, 80) from the electromagnetic part (5e) and a force given to the spool (5s, 80) by action of the drive pressure; and a control device that applies a current to the electromagnetic part (5e) of the pressure regulating device (51, 52, 51B, 52B, 81, 82) so that the drive pressure reaches target pressure (Preq1, Preq2).

The inventors of the present disclosure have conducted intensive studies to allow an artificial muscle that operates by being supplied with liquid to operate with excellent responsiveness and high accuracy. As a result, the inventors have focused on pressure control that has not been yet applied to liquid-driven artificial muscles. Then, the inventors have confirmed that by regulating pressure of liquid to target pressure required for operation of the artificial muscle and supplying the liquid to the artificial muscle, drive pressure supplied to the artificial muscle can substantially match the target pressure within a short period of time after setting the target pressure. Thus, it becomes possible for the robot device of the present disclosure to allow the artificial muscle that operates by being supplied with liquid to operate with excellent responsiveness and high accuracy. Furthermore, by feeding back drive pressure supplied to the artificial muscle to the pressure regulating device, when an external force from a source other than the artificial muscle is applied to a drive target that is driven by the artificial muscle, fluctuations in liquid pressure in the artificial muscle caused by the external force can be smoothed out, and after the external force is removed, drive pressure based on target pressure can be promptly supplied to the artificial muscle.

In addition, the robot device (AM, AMB) may include a pair of the artificial muscles (M1, M2, M1-M6) that is antagonistically driven to allow a drive target to move, and the pressure regulating device (51, 52, 51B, 52B, 81, 82) may be provided for each of the pair of the artificial muscles (M1, M2, M1-M6), and the control device (10) may control, for each of the pressure regulating devices (51, 52, 51B, 52B, 81, 82), a current supplied to the electromagnetic part (5e). By this, it becomes possible to further improve controllability of the artificial muscles.

Furthermore, the artificial muscle (M1, M2, M1-M6) may include a tube T that axially contracts while radially expanding in accordance with supply of liquid to an inside of the tube (T), and the pressure regulating device (51, 52, 51B, 52B, 81, 82) may supply the liquid to the inside of the tube (T).

In addition, the control device (10) may derive a contraction force and a contraction rate for the tube (T) determined based on a requirement for the artificial muscle (M1, M2), and set liquid pressure corresponding to the derived contraction force and contraction rate, as the target pressure (Preq1, Preq2). By this, it becomes possible to accurately set target pressure according to a requirement for the artificial muscle.

Furthermore, the robot device (AM, AMB) may include a plurality of the artificial muscles (M1, M2, M1-M6), and the liquid supply device (1, 1B) may include the single pump (3) and a plurality of the pressure regulating devices (51, 52, 51B, 52B, 81, 82) each regulating the source pressure from the pump (3) side and supplying the regulated source pressure to a corresponding one of the artificial muscles (M1, M2, M1-M6). By this, it becomes possible to significantly reduce the cost and size of the liquid supply device that supplies liquid to the plurality of artificial muscles, compared to, for example, a liquid supply device including a pump for each artificial muscle.

In addition, the pressure regulating device may be a linear solenoid valve (51, 52) that includes the spool (5s) and the electromagnetic part (5e), and regulates the source pressure from the pump (3) side, and the control device (10) may apply, by PWM control, a current generated based on the target pressure (Preq1, Preq2) to the electromagnetic part (5e) of the linear solenoid valve (51, 52). By this, it becomes possible to more accurately regulate pressure of liquid supplied to the artificial muscle to target pressure.

Furthermore, the pressure regulating device may include a solenoid valve (51B, 52B) including the electromagnetic part (5e); and a control valve (81, 82) that includes the spool (8s) and regulates the source pressure from the pump (3) side by balancing a force given to the spool (8s) by action of signal pressure from the solenoid valve (51B, 52B) and a force given to the spool (8s) by action of the drive pressure.

In addition, the artificial muscle (M1, M2, M1-M6) may be a McKibben artificial muscle.

The liquid supply device of the present disclosure is a liquid supply device (1, 1B) that supplies and discharges liquid to/from at least one artificial muscle (M1, M2, M1-M6) that operates by being supplied with the liquid, and the liquid supply device (1, 1B) includes a liquid storage part (2) that stores the liquid; a pump (3) that sucks the liquid from the liquid storage part (2) and discharges the liquid; a pressure regulating device (51, 52, 51B, 52B, 81, 82) that includes a spool (5s, 80) and an electromagnetic part (5e) that allows the spool (5s, 80) to move, and that generates drive pressure for the artificial muscle (M1, M2, M1-M6) by regulating source pressure from a pump (3) side, and regulates the source pressure by balancing at least a force given to a spool (5s, 80) from the electromagnetic part (5e) and a force given to the spool (5s, 80) by action of the drive pressure; and a control device that applies a current to the electromagnetic part (5e) of the pressure regulating device (51, 52, 51B, 52B, 81, 82) so that the drive pressure reaches target pressure (Preq1, Preq2).

It becomes also possible for the liquid supply device to allow an artificial muscle that operates by being supplied with liquid to operate with excellent responsiveness and high accuracy. Furthermore, by feeding back drive pressure supplied to the artificial muscle to the pressure regulating device, when an external force from a source other than the artificial muscle is applied to a drive target that is driven by the artificial muscle, fluctuations in liquid pressure in the artificial muscle caused by the external force can be smoothed out, and after the external force is removed, drive pressure based on target pressure can be promptly supplied to the artificial muscle.

There is no intention that the various aspects of the present disclosure be limited to the above-described embodiment, and needless to say, various changes that fall within the extensive range of the present disclosure can be made. Furthermore, the above-described embodiment is merely a specific embodiment of the disclosure described in the “SUMMARY OF DISCLOSURE” section, and is not intended to limit the elements described in the “SUMMARY OF DISCLOSURE” section.

### INDUSTRIAL APPLICABILITY

The various aspects of the present disclosure can be used in, for example, manufacturing industries for a robot device including at least one artificial muscle that operates by being supplied with liquid, and a liquid supply device that supplies and discharges liquid to/from the artificial muscle.

1. A robot device comprising: at least one artificial muscle that operates by being supplied with liquid; and a liquid supply device that supplies and discharges the liquid to/from the artificial muscle,
wherein
the liquid supply device includes:
a liquid storage part that stores the liquid;
a pump that sucks the liquid from the liquid storage part and discharges the liquid;
a pressure regulating device that includes a spool and an electromagnetic part that allows the spool to move, and that generates drive pressure for the artificial muscle by regulating source pressure from a pump side, and regulates the source pressure by balancing at least a force given to a spool from the electromagnetic part and a force given to the spool by action of the drive pressure; and
a control device that applies a current to the electromagnetic part of the pressure regulating device so that the drive pressure reaches target pressure.

2. The robot device according to claim 1, comprising a pair of the artificial muscles that is antagonistically driven to allow a drive target to move,
wherein
the pressure regulating device is provided for each of the pair of the artificial muscles, and the control device controls, for each of the pressure regulating devices, a current supplied to the electromagnetic part.

3. The robot device according to claim 1, wherein the artificial muscle includes a tube that axially contracts while radially expanding in accordance with supply of liquid to an inside of the tube, and the pressure regulating device supplies the liquid to the inside of the tube.

4. The robot device according to claim 3, wherein the control device derives a contraction force and a contraction rate for the tube determined based on a requirement for the artificial muscle, and sets liquid pressure corresponding to the derived contraction force and contraction rate, as the target pressure.

5. The robot device according to claim 1, comprising a plurality of the artificial muscles,
wherein
the liquid supply device includes the single pump and a plurality of the pressure regulating devices each regulating the source pressure from the pump side and supplying the regulated source pressure to a corresponding one of the artificial muscles.

6. The robot device according to claim 1, wherein
the pressure regulating device is a linear solenoid valve that includes the spool and the electromagnetic part, and regulates the source pressure from the pump side, and
the control device applies, by PWM control, a current generated based on the target pressure to the electromagnetic part of the linear solenoid valve.

7. The robot device according to claim 1, wherein the pressure regulating device includes:
a solenoid valve including the electromagnetic part; and
a control valve that includes the spool and regulates the source pressure from the pump side by balancing a force given to the spool by action of signal pressure from the solenoid valve and a force given to the spool by action of the drive pressure.

8. A liquid supply device that supplies and discharges liquid to/from at least one artificial muscle that operates by being supplied with the liquid, the liquid supply device comprising:
a liquid storage part that stores the liquid;
a pump that sucks the liquid from the liquid storage part and discharges the liquid;
a pressure regulating device that includes a spool and an electromagnetic part that allows the spool to move, and that generates drive pressure for the artificial muscle by regulating source pressure from a pump side, and regulates the source pressure by balancing at least a force given to a spool from the electromagnetic part and a force given to the spool by action of the drive pressure; and
a control device that applies a current to the electromagnetic part of the pressure regulating device so that the drive pressure reaches target pressure.

9. The liquid supply device according to claim 8, wherein the pressure regulating device is provided for each of a pair of the artificial muscles that is antagonistically driven to allow a drive target to move, and the control device controls, for each of the pressure regulating devices, a current supplied to the electromagnetic part.

10. The liquid supply device according to claim 8, wherein the artificial muscle includes a tube that axially contracts while radially expanding in accordance with supply of liquid to an inside of the tube, and the pressure regulating device supplies the liquid to the inside of the tube.

11. The liquid supply device according to claim 10, wherein the control device derives a contraction force and a contraction rate for the tube determined based on a requirement for the artificial muscle, and sets liquid pressure corresponding to the derived contraction force and contraction rate, as the target pressure.

12. The liquid supply device according to claim 8, wherein the liquid supply device includes the single pump and a plurality of the pressure regulating devices each regulating the source pressure from the pump side and supplying the regulated source pressure to a corresponding one of the artificial muscles.
